(19) United States
(12) Patent Application Publication
(10) Pub. No.: US 2008/0273022 A1
(43) Pub. Date: Nov. 6, 2008

(54) ELECTROPHORESIS DISPLAY DEVICE, DRIVING METHOD OF ELECTROPHORESIS DISPLAY DEVICE, AND ELECTRONIC APPARATUS

(75) Inventor: Yuko KOMATSU, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/034,073

(22) Filed: Feb. 20, 2008

(30) Foreign Application Priority Data
Mar. 7, 2007 (JP) 2007-056956

(51) Int. Cl. G09G 5/00; G09G 3/34

(52) U.S. Cl. 345/205; 345/107

(57) ABSTRACT

An electrophoresis display device includes a first electrode, a second electrode facing the first electrode, an electrophoresis element interposed between the first electrode and the second electrode and containing charged electrophoresis particles, a pixel including a first pixel circuit and a second pixel circuit which give a potential difference between the first electrode and the second electrode, a first scan line and a first data line which are connected to the first pixel circuit, and a second scan line and a second data line which are connected to the second pixel circuit, in which a signal supplied to the first pixel circuit from the first data line during a select period specified by a select signal of the first scan line is an erase signal, and wherein a signal supplied to the second pixel circuit from the second data line during a select period specified by a select signal of the second scan line is an image signal.

### BACKGROUND

1. Technical Field

The present invention relates to an electrophoresis display device, a driving method of an electrophoresis display device, and an electric apparatus.

2. Related Art

In electrophoresis display devices, if a potential difference is given between electrodes which holds an electrophoresis element in between, charged electrophoresis particles move in the electrophoresis element and thus forms a picture by the color of the electrophoresis particles moved to the electrode on the display surface side. Furthermore, even after the potential difference between electrodes is lost, the electrophoresis particles cannot be moved and thus the formed picture can be maintained.

JP-A-2002-149115 discloses a picture write method as a method of updating a picture in such electrophoresis displays. According to the picture write method, a new picture is written after performing erase operation of image data of a previous picture with respect to all the pixels of a display section.

This method has a problem in that erase operation is performed with respect to all the pixels by the same method even if the pixels display different colors in the previous picture. However, the electrophoresis elements are differently affected by the erase operation in the case in which the pixels that have displayed white undergo the erase operation and then come to display white after the erase operation and in the case in which the pixels that have displayed black undergo the erase operation and then come to display white after the erase operation.

In the case in which the erase operation is performed many times in such a manner, the potential balance in the electrophoresis particles may become uneven between pixels, and a white display may remain as an afterimage in write operation. If the electrophoresis display device falls to such a state, it will become impossible to display a desired picture.

Moreover, even if the afterimage of the previous picture does not remain, stress is given to a user of an electronic apparatus equipped with the electrophoresis display device because a picture of a single color would be temporarily displayed on the entire surface by the erase operation whenever a picture is updated.

### SUMMARY

An advantage of some aspects of the invention is that it provides an electrophoresis display device which does not have an afterimage in an updated picture and does not display a picture of a single color temporarily, a driving method of the electrophoresis display device, and an electronic apparatus equipped with the electrophoresis display device.

According to aspects of the invention, there are provided an electrophoresis display device, a driving method of the electrophoresis display device, and an electronic apparatus equipped with the electrophoresis display device.

According to one aspect of the invention, there is provided an electrophoresis display device including a first electrode, a second electrode facing the first electrode, an electrophoresis element interposed between the first electrode and the second electrode and containing charged electrophoresis particles, a pixel including a first pixel circuit and a second pixel circuit which give a potential difference between the first electrode and the second electrode, a first scan line and a first data line which are connected to the first pixel circuit, and a second scan line and a second data line which are connected to the second pixel circuit, in which a signal supplied to the first pixel circuit from the first data line during a select period specified by a select signal of the first scan line is an erase signal, and wherein a signal supplied to the second pixel circuit from the second data line during a select period specified by a select signal of the second scan line is an image signal.

In the electrophoresis display device, it is preferable that the electrophoresis display device further includes a fist scan line driving circuit connected to the first scan line, a second scan line driving circuit connected to a second scan line, and a data line driving circuit connected to the first data line and the second data line. Thanks to such a structure, it is possible to realize an electrophoresis display device which uses separate scan line driving circuits for inputting a select signal into the pixel which performs erase operation and for inputting a select signal into the pixel which performs write operation.

In the electrophoresis display device, it is preferable that the electrophoresis display device further includes a first scan line driving circuit connected to the first scan line, a second scan line driving circuit connected to the second scan line, a first data line driving circuit connected to the first data line, and a second data line driving circuit connected to the second data line. Thanks to such a structure, it is possible to realize an electrophoresis display device which uses separate data line driving circuits for inputting an erase signal into the pixel and for inputting an image signal into the pixel.

In the electrophoresis display device, it is preferable that the select signal by the first scan line and the select signal by the second scan line are not simultaneously supplied to the pixels. Accordingly, the erase signal and the image signal are not simultaneously inputted into the pixels, and thus it is possible to realize an electrophoresis display device which does not mix up a picture.

In the electrophoresis display device, it is preferable that the display section of the electrophoresis display device includes a plurality of the pixels, and it is preferable that supply of the select signal to the first pixel by the first scan line and supply of the select signal to the second pixel by the second scan line are concurrently performed in the display section. With such a structure, it is possible to perform the write operation while performing the erase operation since it is possible to allow the erase operation and the write operation to be performed in different pixels, respectively. Therefore, it is possible to realize an electrophoresis display device that can perform rewrite operation of the picture while avoiding the state in which all the pixels are erased.

As for the erase signal, it is preferable that the erase signal is an inversion signal of the image signal inputted into the same pixels just previously. Accordingly, it is possible to realize an electrophoresis display device which can maintain the potential balance in the electrophoresis element during the erase operation.

According to another aspect of the invention, there is provided an electrophoresis display device including a first electrode, a second electrode facing the first electrode, an electrophoresis display element interposed between the first electrode and the second electrode and containing charged electrophoresis particles, a pixel circuit giving a potential difference between the first electrode and the second electrode, a scan line connected to the pixel circuit, and a data select circuit which is connected to a first data line and a second data line as well as it is connected to the pixel circuit and which switches an input signal of data between the first data line and the second data line. Thanks to the structure, it is possible to simplify the pixel circuit by reducing the number of scan lines and the number of scan line driving circuits, resulting in the decrease of the manufacturing cost.

In the electrophoresis display device, it is preferable that the electrophoresis display device further includes a scan line driving circuit which drives a signal of the scan line, a first data line driving circuit which drives the first data line, a second data line driving circuit which drives the second data line, and a control section which controls the scan line driving circuit, the first data line driving circuit, the second data line driving circuit, and the data select circuit. With such a structure, it is possible to realize an electrophoresis display device which can reduce the design cost by obviating the need of a plurality of control sections.

In the electrophoresis display device, it is preferable that a display section of the electrophoresis display device includes a plurality of the pixel circuits, in which a first select period which is specified by a signal of the scan line for the first pixel circuit and in which the signal of the first data line is selected as the input signal of data, and a second select period which is specified by the signal of the scan line for the second pixel circuit and in which the signal of the second data line is selected as the input signal of data concurrently exist. Thanks to such a structure, it is possible to realize an electrophoresis display device in which different pixels can be simultaneously selected so that the erase operation and the write operation are performed concurrently.

In the electrophoresis display device, it is preferable that the signal of the first data line is an erase signal and the signal of the second data line is an image signal. Thanks to such a structure, it is possible to realize an electrophoresis display device in which the erase signal and the image signal can be simultaneously inputted into different pixels, respectively.

In the electrophoresis display device, it is preferable that the erase signal is an inversion signal of the image signal inputted into the same pixel just previously. Thus, it is possible to realize an electrophoresis display device in which the potential balance can be maintained during the erase operation.

According to a further aspect of the invention, there is provided a driving method of an electrophoresis display device including a first electrode, a second electrode facing the first electrode, an electrophoresis element interposed between the first electrode and the second electrode and containing charged electrophoresis particles; a first pixel circuit connected to a first scan line and a first data line which give a potential difference between the first electrode and the second electrode, a second pixel circuit connected to a second scan line and a second data line which give a potential difference between the first electrode and the second electrode, and a pixel including the first pixel circuit and the second pixel circuit, in which a display section of the electrophoresis display device includes a plurality of the pixels, the driving method including a first step of supplying a select signal of the first scan line to the first pixel circuit of the pixel of a first region of the display section and an erase signal to the first data line, a second step of supplying a select signal of the second scan line to the second pixel circuit of the pixel of the first region and an image signal to the second data line, a third step of supplying a select signal of the first scan line to the first pixel circuit of a pixel of the second region of the display section and an erase signal to the first data line, and a fourth step of supplying a select signal of the second scan line to the second pixel circuit of the pixel of the second region and an image signal to the second data line, in which the electrophoresis display device has a first period in which the first step and the fourth step are simultaneously performed and a second period in which the second step and the third step are simultaneously performed. With such a driving method, the erase operation and the write operation can be currently performed with respect to different pixels in an electrophoresis display device.

It is desirable that the input of the select signal via the first scan line and the input of the select signal via the second scan line concurrently performed. Thereby, it is possible to realize an electrophoresis display device in which the erase operation and the write operation can be simultaneously performed in different pixels, respectively.

In the electrophoresis display device, it is preferable that the erase signal is an inversion signal of the image signal inputted into the same pixel just previously. Thus, it is possible to realize a driving method of an electrophoresis display device, which can maintain the potential balance during the erase operation.

According to a still further aspect of the invention, there is provided an electronic apparatus provided with the electrophoresis display device according to the invention. By using the electrophoresis display having such structures, it is possible to realize an electronic apparatus which has no afterimage in an updated picture and a picture of a single color is not displayed temporarily.

### BRIEF DESCRIPTION OF THE DRAWINGS

The invention will be described with reference to the accompanying drawings, wherein like numbers reference like elements.

FIG. 1 is a view illustrating an electrophoresis display device 1.

FIG. 2 is a circuit diagram illustrating a pixel 2.

FIG. 3 is a sectional view illustrating a display section 3 of the electrophoresis display device 1.

FIG. 4 is a view illustrating the inside structure of a microcapsule 30.

FIG. 5 is an explanatory view for explaining operation of the microcapsule 30.

FIG. 6 is a timing chart illustrating write operation.

FIG. 7 is a view illustrating the relationship between potentials during the write operation.

FIG. 8 is a view illustrating movement of electrophoresis particles during erase operation.

FIG. 9 is a schematic view illustrating the display section 3 at the time of the write operation.

FIG. 10 is a schematic view illustrating movement of the electrophoresis particles at the time of the write operation.

FIG. 11 is a schematic view illustrating a structure of an electrophoresis display device 100 according to a second embodiment.

FIG. 12 is a schematic view illustrating an electrophoresis display device 200.

FIG. 13 is a circuit diagram illustrating a pixel 200.

FIG. 14 is a timing chart according to a third embodiment.

FIG. 15 is a view illustrating one exemplary electronic apparatus equipped with the electrophoresis display device 1 according to the invention.

FIG. 16 is a view illustrating another exemplary electronic apparatus equipped with the electrophoresis display device 1 according to the invention.

### DESCRIPTION OF EXEMPLARY EMBODIMENTS

### First Embodiment

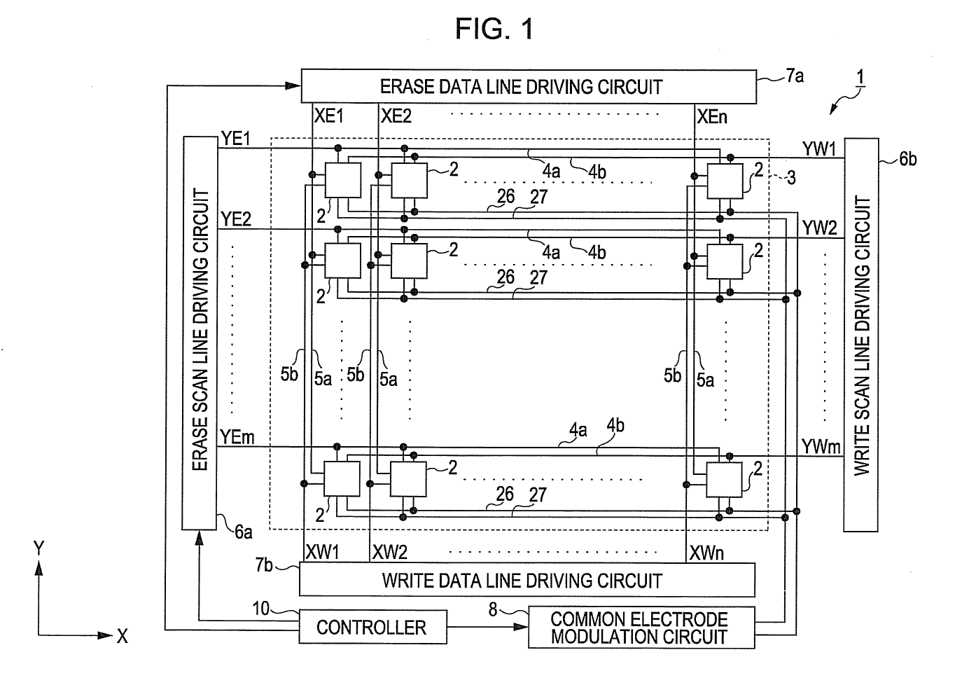

Hereinafter, an electrophoresis display device according to the invention will be described with reference to the accompanying drawings. FIG. 1 is a view illustrating a structure of an electrophoresis display device 1 according to one embodiment of the invention. As shown in FIG. 1, the electrophoresis display device 1 includes a display section 3 in which pixels 2 are arranged in a matrix form of M rows×N columns where M pixels are arranged in a Y-axis direction and N pixels are arranged in an X-axis direction. The electrophoresis display device 1 further includes M erase scan lines 4a (YE1, YE2, . . . , YEm) each extending along the display section 3 in the X-axis direction, M write scan lines 4b (YW1, YW2, . . . , YWm) each extending along the display section 3 in the X-axis direction, N erase data lines (XE1, XE2, . . . , XEn) each extending along the display section 3 in the Y-axis direction, N write data lines 5b (XW1, XW2, . . . , XWn) each extending along the data section 3 in the Y-axis direction, an erase scan line driving circuit 6a which inputs a select signal into the pixels 2 via the erase scan lines 4a, a write scan line driving circuit 6b which inputs a select signal into the pixels 2 via the write scan lines 4b, an erase data line driving circuit 7a which inputs an erase signal into the pixels 2 via the erase data lines 5a, a write data line driving circuit 7b which inputs an image signal into the pixels 2 via the write data lines 5b, a common electrode modulation circuit 8 which inputs a signal into a common electrode (second electrode, not shown) of the pixel 2 via a common electrode power supply wiring 26 and inputs a holding capacitor signal (not shown) of the pixel 2 via a holding capacitor power supply wiring 27, and a controller 10 which inputs a signal into the two scan line driving circuits, the two data line driving circuits, and the common electrode modulation circuit 8. Since the potential of the common electrode is the same for all the pixels 2, the common electrode power supply wiring 26 is used as a shared wiring. Since the holding capacitor power supply wiring 27 is also shared by all the pixels 2, the holding capacitor power supply wiring 27 is also maintained at a certain fixed potential.

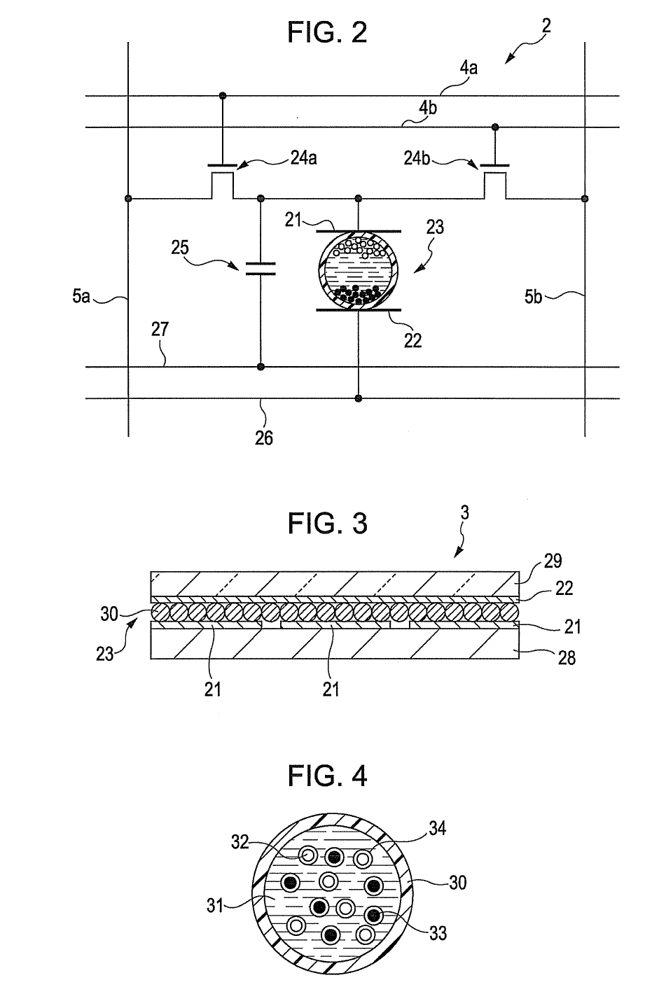

FIG. 2 shows a circuit structure of the pixel 2. As shown in FIG. 2, a picture electrode (first electrode) 21 is connected with the erase data line 5a via an erase TFT (first pixel circuit) 24a and with the write data line 5b via a write TFT (second pixel circuit) 24b. On the other hand, the common electrode (the second electrode) 22 is connected with the common electrode power supply wiring 26. A gate of the erase TFT 24a is connected with the erase scan line 4a and a gate of the write TFT 24b is connected with the write scan line 4b. The electrophoresis element 23 is interposed between the picture electrode 21 and the common electrode 22. One electrode of the holding capacitor 25 is connected with the erase TFT 24a, the write TFT 24b, and the picture electrode 21. The other electrode of the holding capacitor 25 is connected with the holding capacitor power supply wiring 27. The holding capacitor 25 is used in order to maintain image data, when the erase TFT 24a or the write TFT 24b is in an OFF state.

FIG. 3 is a sectional view illustrating a display section 3 of the electrophoresis display device 1. As shown in FIG. 2, the display section 3 has a structure in which the picture electrodes 21 formed on an element substrate 28 and the common electrode 22 formed on a counter substrate 29 hold the electrophoresis elements 23 each constituted by a plurality of microcapsules 30 in between.

The element substrate 28 is a substrate manufactured by molding a material, such as glass and a plastic, in the rectangle. The picture electrodes 21 are formed on the element substrate 28, and each of the picture electrodes 21 is formed in the rectangle for every pixel 2. Although illustration is omitted, the scan lines 4, the data lines 5, the common electrode power supply wiring 26, the holding capacitor power supply wiring 27, and the TFTs 24 are formed at regions every between picture electrodes 21, or regions under the picture electrodes 21.

Since the counter substrate 29 serves as a display substrate on which a picture is displayed, the counter substrate 29 is made of translucent material, such as glass, and formed in the rectangle. The common electrode 22 formed on the counter substrate 29 is made of a material having translucency and conductivity, for example, magnesium silver MgAg, indium tin oxide (ITO), indium and zinc oxide(IZO), etc.

FIG. 4 shows a structure of the microcapsule 30. The microcapsule 30 has a particle diameter of about 50 micrometers and is made of translucent polymer resin, such as acrylic resins, such as poly methyl methacrylate and polymethacrylic acid ethyl, urea resin, and gum Arabic. The microcapsule 30 is interposed between the common electrode 22 and the picture electrode 21, and one pixel includes a plurality of the microcapsules 30 arranged in a longitudinal direction and a widthwise direction thereof. Binder (not shown) which fixes the microcapsules 30 is provided around the microcapsules 30 so that the microcapsules 30 are buried in the binder.

Each of the microcapsules 30 seals a dispersion medium 31 and charged particles including a plurality of white particles 32 and a plurality of black particles 33 disposed therein.

As the dispersion medium 31, for example water; Alcoholic system solvents, such as methanol, ethanol, isopropanol, butanol, octanol, and methyl cellosolve; various ester, such as ethyl acetate and butyl acetate; various ketone, such as acetone, methyl ethyl ketone, methyl isobutyl ketone; aliphatic hydrocarbon, such as pentane, hexane, and octane; alicyclic hydrocarbon, such as cyclohexane and methylcyclohexane; aromatic hydrocarbon, such as benzene which has a long chain alkyl group, for example, benzene, toluene, xylene, hexyl benzene, heptane, hebuthyl benzene, octyl benzene, nonyl benzene, decyl benzene, and tetradecyl benzene; halogenated hydrocarbon, such as methylene chloride, chloroform, carbon tetrachloride, and 1,2-dichloroethane; carboxylate; and other kinds of oils are used alone or in combination in the form of a mixture with a surfactant. The white particles 32 and the black particles 33 are dispersed in the microcapsule 30.

The white particles 32 are particles (a macromolecule or colloid), which consist of white pigments, such as titanium dioxide, flower of zinc (zinc oxide), and antimony trioxide, and are charged in negative.

The black particles 33 are particles (a macromolecule or colloid) which consist of black pigments, such aniline black and carbon black, and are charged in positive.

For this reason, the white particles 32 and the black particles 33 can move in the middle of electric field generated due to the potential difference between the picture electrode 21 and the common electrode 22 in dispersion medium 31.

According to circumstances, an electrolyte, a surfactant agent, a charge control agent which consists of particles, such as metal soap, resin, rubber, oil, varnish, and a compound, a dispersing agents, such as a titanium-based coupling agent, an aluminum-based coupling agent, and a silane-based coupling agent, a lubricant, a stabilizer can be added to the pigments.

The white particles 32 and the black particles 33 are covered with ions in a solvent, and thus an ionized layer 34 is formed on the surface of each of the particles. The electric double layer is formed between each of the charged white particles 32 and the ionized layer 34 and between each of the charged black particles 33 and the ionized layer 34. It is generally known that even if the charged particles such as the white particles 32 and the black particles 33 are applied with the electric field with a frequency of 10 kHz or more, the charged particles hardly reacts to the electric field and thus hardly move. It is further known that the ions surrounding the charged particles will move according to the electric field if the ions are applied with the electric field with a frequency of 10 kHz or more since the diameter of the ions is far small compared with the charged particles.

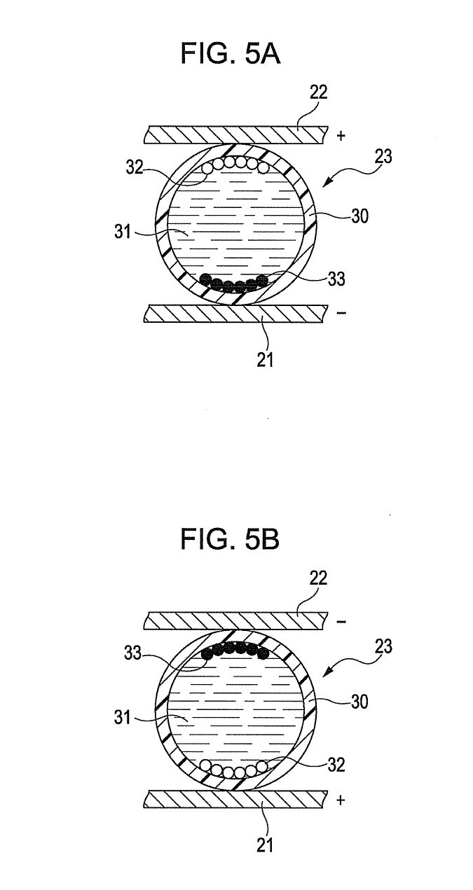

FIG. 5 shows operation of the particles in the microcapsule 30. Here, the ideal case, in which the ionized layer 34 is not formed, is described as an example. If voltage is applied between the picture electrode 21 and the common electrode 22 in a manner such that the potential of the common electrode 22 is relatively high, as shown in FIG. 5A, the black particles 33 charged in positive can be drawn near to the picture electrode 21 within the microcapsule 30 due to coulomb force. On the other hand, the white particles 32 charged in negative can be drawn near to the common electrode 22 within the microcapsule 30 due to the coulomb force. As a result, the white particles 32 will gather at the display surface side in the microcapsule 30, and the color (white) of the white particles 32 will be displayed on the display surface.

Conversely, if voltage is applied between the picture electrode 21 and the common electrode 22 in a manner such that the potential of the picture electrode 21 is relatively high, as shown in FIG. 5B, the white particles 32 charged in negative can be drawn near to the picture electrode 21 due to the coulomb force. On the contrary, the black particles 33 charged in positive can be drawn near to the common electrode 22 due to the coulomb force. As a result, the black particles 33 will gather at the display surface side of the microcapsule 30, and thus the color (black) of the black particle 33 will be displayed on the display surface.

Further, it is possible to realize an electrophoresis display device 1 which displays red, green, blue, etc by using pigments of red, green, blue, etc. instead of the white particles 32 and the black particles 33.

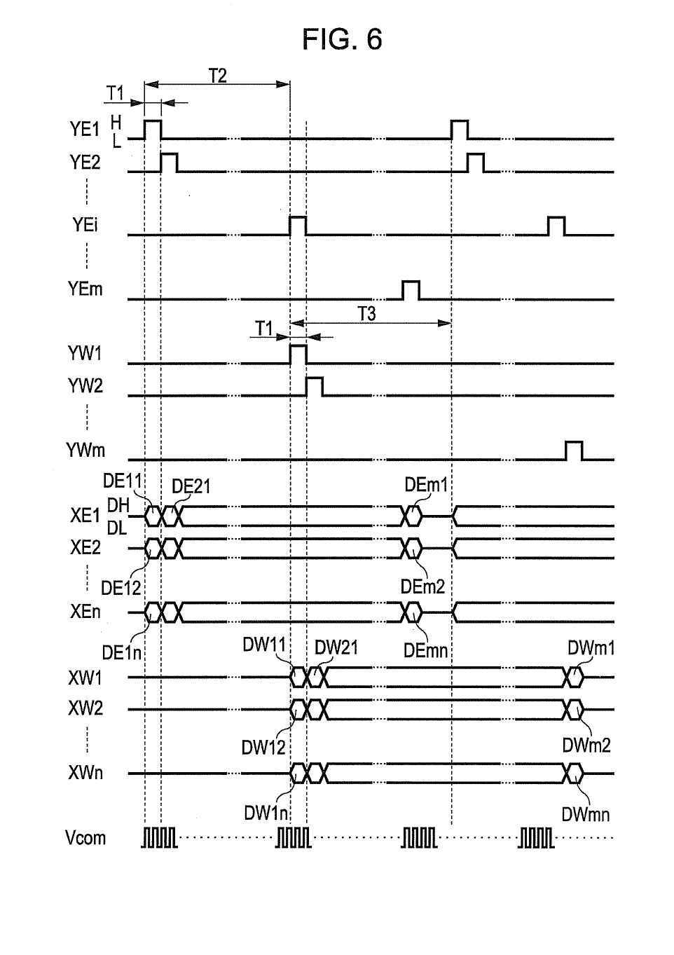

Hereinafter, rewrite operation of a picture in the above-described electrophoresis display device 1 according to the invention will be explained. FIG. 6 is a timing chart showing the waveform of signals applied to the erase scan line 4a, the write scan line 4b, the erase data line 5a, the write data line 5b, and the common electrode 22, respectively at the time of the rewrite operation. In FIG. 1, the M erase scan lines 4a from the upper end of the display section 3 are consecutively called YE1, YE2, . . . , YEm, the M write scan line 4b from the upper end of the display section 3 are consecutively called YW1, YW2, . . . , YWm, the N erase data lines 5a from the left end of the display section 3 are consecutively called XE1, XE2, . . . , XEn, and the N write data lines 5b from the left end of the display section 3 are consecutively called XW1, XW2, . . . , XWn. In addition, an erase signal and an image signal in association with the pixels 2 connected to the erase scan lines YEi(1≦i≦m) and the erase data lines XEj (1≦j≦m) are referenced by DEij and DWij, respectively.

The erase signal DE is inputted into the pixels 2 connected to the erase scan line 4a to which a select signal has been supplied by the erase scan line driving circuit 6a, and the write signal DW is inputted into the pixels 2 connected to the write scan line 4b to which a select signal has been supplied by the write scan line driving circuit 6b.

The erase scan line driving circuit 6a sequentially selects the erase scan lines one by one from the erase scan line YE1 to the erase scan line YEm, and the write scan line driving circuit 6b sequentially selects the write scan lines one by one from the write scan line YW1 to the write scan line YWm. However, the erase scan line driving circuit 6a and the write scan line driving circuit 6b select different scan lines, respectively, and then the erase operation progresses further.

In a certain pixel 2, when a predetermined period T2 passes after starting of the erase operation, the write operation starts and the image signal DW is inputted.

In this embodiment, timing that the erase scan line driving circuit 6a inputs the select signal into the pixels 2 connected to the erase scan line YEi via the erase scan line YEi and timing that the write scan line driving circuit 6b inputs the select signal into the pixels 2 connected to write scan line YW1 via the write scan line YW1 are coincident.

For this reason, the erase operation by the erase scan line driving circuit 6a and the erase data line driving circuit 7a and the write operation by the write scan line driving circuit 6b and the write data line driving circuit 7b are simultaneously performed with respect to the pixels 2 in different lines in the display section 3.

In this embodiment, the erase operation is defined as an operation that makes the pixels 2 display white and the write operation is defined as an operation that makes the pixels 2 display black. As the erase signal DE, the inversion signal of the image signal DW of the previous picture is used. Moreover, the signal inputted into the common electrode 22 is always in a pulse form consisting of periods of high-level COMH and periods of low-level COML which are periodically repeated at a fixed cycle, in which each period is shorter than T1.

As for the frequency of the signal inputted into the common electrode 22, it is preferable that it is 30 Hz or more. When the frequency is 30 Hz or more, a display picture do not flicker and thus a user does not feel stress.

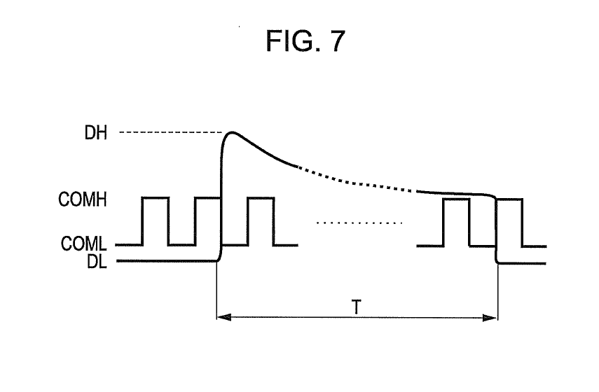

FIG. 7 shows the relationship between potentials of the signals inputted into the picture electrode 21 and the common electrode 22. The potential Vcom of the signal inputted into the common electrode 22 consists of COMH and COML, and the potentials of the erase signal DE and the image signal DW inputted into the picture electrode 21 are DH (high-level) and DL (Low-level). The relationship between such potentials are DL<COML<COMH<DH, as shown in FIG. 7.

The potential of the picture electrode 21 falls from DH while time passes. It is because the holding capacitor 25 is not charged when the erase TFT 24a and the write TFT 24b are in an OFF state, so the potential currently held at the holding capacitor 25 falls due to the off-leak current attributable to the erase TFT 24a, the write TFT 24a, the substrate surrounding the TFTs, etc.

However, the electrophoresis display device 1 according to this embodiment is designed so as to maintain the state COMH<DH for a period T between completion of the input of the image signal DW and the input of the erase signal DE, which is performed for preparation of the display of a subsequent picture.

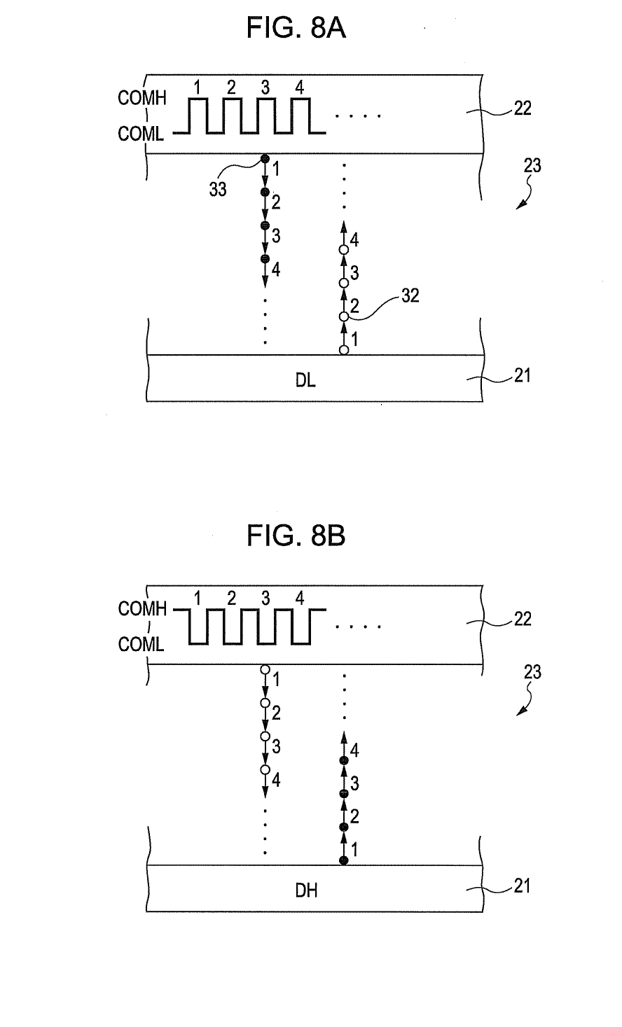

FIGS. 8A and 8B are schematic views illustrating movement of electrophoresis particles when the signal with the potential Vcom consisting of the periods of COMH and the periods of COML which are periodically repeated is inputted into the common electrode 22. FIG. 8A shows the situation in which the pixel 2 which has displayed black in the previous picture changes so as to display white by the erase operation. An inversion signal of the previous picture is inputted into the picture electrode 21 as the erase signal DE (potential DL). When the potential Vcom of the common electrode 22 is COMH, a large potential difference is created between the picture electrode 21 and the common electrode 22. Thus, the black particles 33 move toward the picture electrode 21, and the white particles 32 progress toward the common electrode 22.

On the other hand, when the potential Vcom of the common electrode 22 is COML, the potential difference between the picture electrode 21 and the common electrode 22 is small. This small potential difference negligibly affects the electrophoresis particles, and thus movement of the electrophoresis particles accelerated when the potential Vcom of the common electrode 22 is COMH is slowed down by the collision with the dispersion medium 31 in the microcapsule 30. Therefore, only when the potential Vcom of the common electrode 22 is COMH, the electrophoresis particles move and the erase operation is carried out.

FIG. 8B shows the situation in which the pixel 2 which has displayed white in the previous picture changes so as to display black by the write operation. The pixel electrode 21 is inputted with the image signal DW (potential DH). When the potential Vcom of the common electrode 22 is COML, a large potential difference is created between the picture electrode 21 and the common electrode 22. Thus, the white particles 32 move toward the picture electrode 21, and the black particles 33 progress toward the common electrode 22.

Conversely, when the potential Vcom of the common electrode 22 is COMH, the potential difference between the picture electrode 21 and the common electrode 22 is small. This small potential difference negligibly affects electrophoresis particles, and movement of the electrophoresis particles accelerated when the potential Vcom of the common electrode 22 is COML is slowed down by the collision with the dispersion medium 31 in the microcapsule 30. Therefore, only when the potential Vcom of the common electrode 22 is COML, electrophoresis particles move and the write operation is carried out.

In order to perform rewrite operation, first, the potential of the erase scan line YE1 changes to high-level (hereinafter, referred to as “H”) from low-level (hereinafter, referred to as “L”) only for a predetermined period T1, and thus the N pixels 2 connected to erase scan line YE1 are selected by the erase scan line driving circuit 6a. Through such a processing, the erase TFTs 24a in the N pixels 2 are turned on, and the N picture electrodes 21 are connected to the erase data lines XE1 XE2, . . . , and XEn, respectively. Thus, the erase operation of the previous picture is started. Next, during the period T1, the erase signals DE11, DE12, . . . , DE1n are inputted into the picture electrodes 21 from the erase data line driving circuit 7a via the erase data lines XE1, XE2, . . . , XEn, and thus data of the previous picture is erased and the holding capacitors 25 is charged. Then, the erase scan line driving circuit 6a cancels the selected state of the N pixels 2 connected to erase scan line YE1 by changing the potential of the erase scan line YE1 from H to L. The erase operation is continuously performed in the pixels 2 thanks to the potential held by the holding capacitor 2 and the potential Vcom of the common electrode 22 until the pixels 2 are selected by a write circuit even after the erase TFTs 24a are in an OFF state.

When the image data is erased by the erase signals DE11, DE12, . . . , DE1n, the N pixels 2 connected to the erase scan line YE1 display the same color (white) altogether.

The potential of the erase scan line YE2 of the following stage changes from L to H by the erase scan line driving circuit 6a the same time when the selected state of the pixels 2 connected to erase scan line YE1 is canceled. After the pixels 2 connected to erase scan line YE2 are selected by the above operation and erasing of the image data and charging of the holding capacitor 25 are performed, the potential of the erase scan line YE2 changes from H to L. By repeatedly performing the same operation with respect to all the pixels 2 connected to the erase scan line YEm, the entire data corresponding to all the pixels 2 of the display section 3 is erased. In addition, as mentioned above, the potential Vcom of the common electrode 22 consists of the period of COMH and the period of COML which are periodically repeated. However, only when the potential Vcom of the common electrode 22 is in the period of COMH the electrophoresis particles move and the erase operation is performed.

In the pixels 2 connected to the erase scan line YE1, when a predetermined period T2 passes after the erase operation is started, the potential of the write scan line YW1 changes from L to H, and the write operation comes to start by the write scan line driving circuit 6b. The period T2 is set such that the erase of the image data in the pixels 2 is fully performed and that the potential balance inside the electrophoresis element 23 is not lost by superfluous erase.

For the predetermined period T1, the potential of the write scan line YW1 changes from L to H, the write TFT 24b is turned on, and the N picture electrodes 21 are connected to the write data lines XW1, XW2, . . . , XWn, respectively. Further, the erase signals DW11, DW12, . . . , DW1n are inputted into the picture electrodes 21 via the write data lines XW1, XW2, . . . , XWn, respectively by the write data line driving circuit 7b. After performing the write operation of new image data and the charge of the holding capacitor 25, the potential of the write scan line YW1 changes from H to L by the write scan line driving circuit 6b, and the state, in which the N pixels 2 connected to the write scan line YW1 are selected, is canceled. Even after the write TFTs 24b are turned off, the write operation is continuously performed in the pixels 2 thanks to the potential held by the holding capacitor 25 and the potential Vcom of the common electrode 22.

When the period T1 passes, the pixels 2 connected to the write scan line YW2 for the following write stage are selected by the write scan line driving circuit 6b and thus the write operation with respect to the selected pixels 2 is performed as soon as the state in which the pixels 2 connected to the write scan line YW1 are selected is canceled. By succeedingly performing such write operation with respect to the pixels 2 until the pixels 2 connected to the last write scan line YWm undergo the write operation, the write operation to all the pixels 2 is completed. The write operation is succeedingly performed for a period T3 until the pixels 2 are selected for erase, which is preparation for a next image display, by the erase scan line driving circuit 6a. The period T3 is sufficient time for displaying a desired image. In addition, the potential Vcom of the common electrode 22 consists of the period of COMH and the period of COML which are periodically repeated. However, the write operation is performed only when the potential Vcom of the common electrode 22 is in the period of COML.

In the electrophoresis display device 1 according this embodiment, since the write circuit and the erase circuit are separately employed, it is possible to concurrently perform the write operation and the erase operation. Accordingly, it is possible to start the write operation with respect to the pixels 2 in which data has already erased without waiting the erase operation respect to all the pixels 2 are completed. Thanks to such processing, it is possible to realize the electrophoresis display device in which a single color of white or black is not temporarily displayed at the time of the rewrite operation of a picture, which makes a user use the electrophoresis display device 1, without feeling stress.

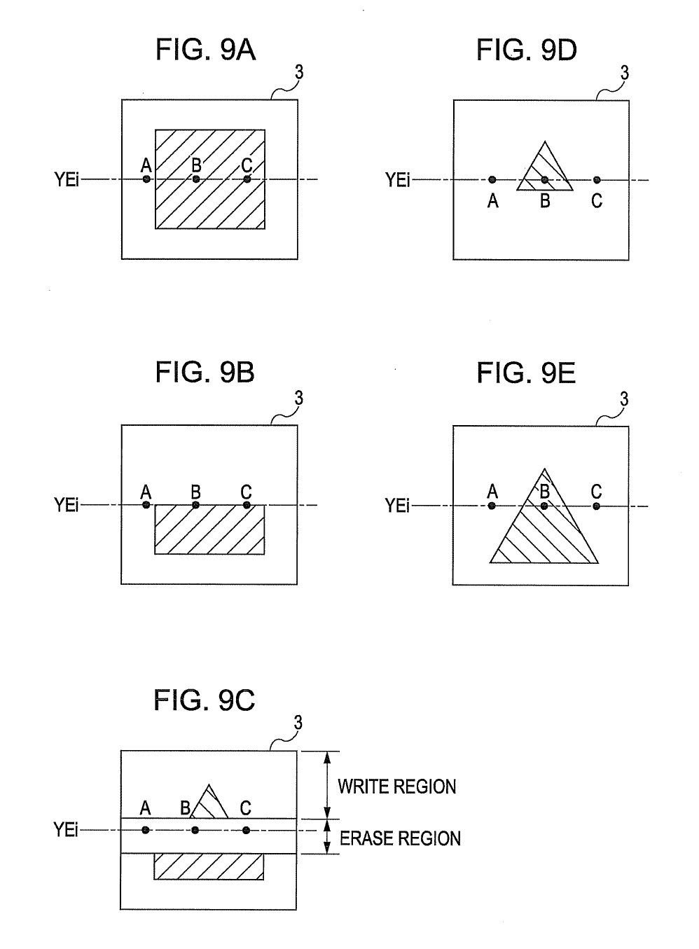

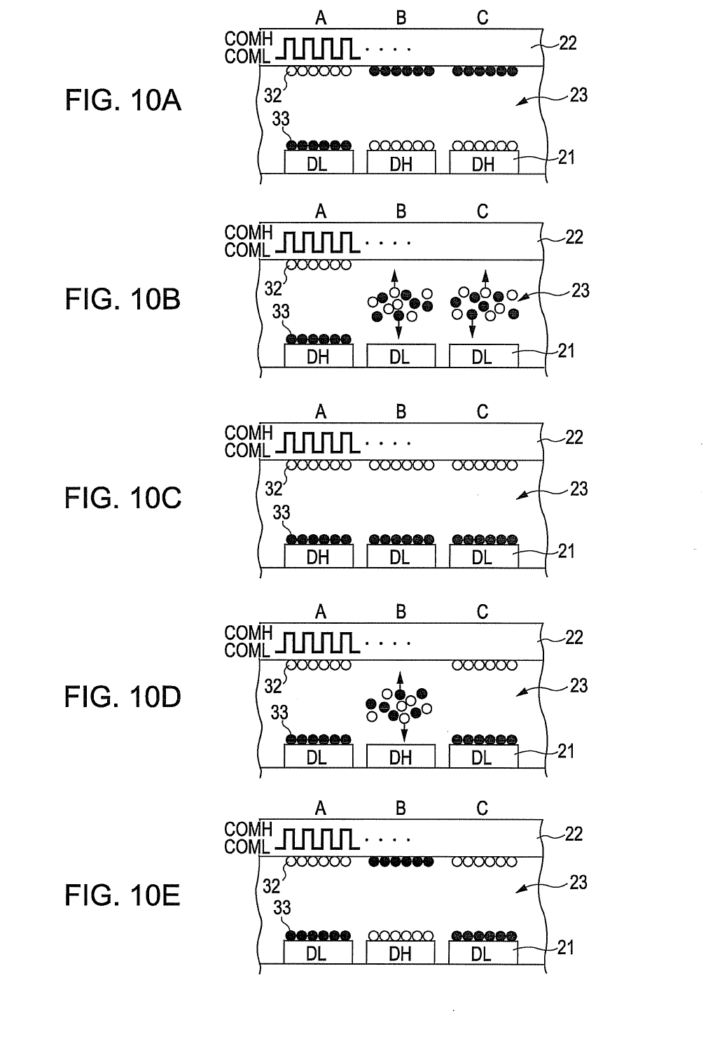

The example of the rewrite operation described above, the potentials of the electrodes at that time, and the movement of the white particles 32 and the black particles 33 in the electrophoresis element 23 will be described below in detail with reference to FIG. 9 and FIG. 10.

FIG. 9 schematically shows the display section 3 at the time of rewrite operation in the electrophoresis display device 1 according to the invention. FIG. 9 shows the situation in which a quadrangle of a previous picture is rewritten by a triangle. At this time, three pixels A, B, and C are selected from the pixels 2 connected to a certain erase scan line YEi (1<i≦m) near a central portion of the display section 3, and movement of the electrophoresis particles in these three pixels A, B, and C at the time of the rewrite operation will be explained. FIG. 10 shows the potentials of both electrodes of each of the pixels A, B, and C and the movement of the white particles 32 and the black particles 33 at the time of the rewrite operation.

Before the rewrite operation starts, a quadrangle is displayed on the display section 3, and the electrophoresis display device 1 at this time is in the state in which the write operation of a previous picture is completed and the previous picture is maintained. This state is shown in FIG. 9A. In this state, the pixel A displays white, and the pixels B and C display black. The potentials of the pixel electrodes 21 in the pixels A, B, and C are DL, DH, and DH respectively. As for the potential Vcom of the common electrode 22, the period of COMH and the period of COML are periodically repeated as shown in FIG. 10A.

The rewrite operation is performed from the upper end of the display section 3. In the image, part of the image, which corresponds to the pixels 2 connected to the erase scan lines YE1 to YEi is eliminated, and thus the image data corresponding to the pixels 2 connected to the erase scan lines YE1 to YEi is erased. Further, since the erase operation is not performed yet in the lower domain from the erase scan line YEi, part of the quadrangle which is a previous picture remains as shown in FIG. 9B.

The pixels A, B, and C operate at this time in a manner as shown in FIGS. 10B and 10C. In the erase operation, since the inversion signal of the image signal DW of a previous picture is inputted into the picture electrode 21 as the erase signal DE, the potential of the picture electrode 21 of the pixel A changes from DL to DH, the potential of the picture electrode 21 of the pixel B changes from DH to DL, and the potential of the picture electrode 21 of the pixel C changes from DH to DL. As for the potential Vcom of the common electrode 22, the period of COMH and the period of COML are periodically repeated.

For this reason, a large potential difference is not created between both electrodes in the pixel A when the potential Vcom of the common electrode 22 is COMH. Accordingly, electrophoresis particles negligibly move. Therefore, a white display is maintained. In the pixels B and C, a large potential difference is created between both electrodes in each pixel, and thus the black particles 33 move to the picture electrode 21 and the white particles 32 move to the common electrode 22. When the potential Vcom of the common electrode 22 is COML, a large potential difference is created in the pixel A, but this does not have big influence on movement of the electrophoresis particles because a period in which the potential Vcom of the common electrode 22 is COMH is very short. Accordingly, there is no likelihood that the white particles 32 separate from the common electrode 22 greatly in such a situation. Since a large potential difference is not created between both the electrodes in each of the pixels B and C, movement of electrophoresis particles is not influenced by the potential difference but is slowed down by the collision with dispersion medium 31. By the repeat of such operation, the pixels A, B, and C fall to the state shown in FIG. 10C through the state shown in FIG. 10B.

Next, when the predetermined period T2 passes after the erase operation is started, the write operation starts. Thus, the display section 3 falls to the state shown in FIG. 9C in which some of the pixels 2 undergoes the write operation but another some of the pixels 2 undergoes the erase operation.

After the erase operation is completed with respect to the pixels 2 connected to the erase scan lines YE1 to YEm, only the write operation is performed (see FIG. 9D). If the write operation is completed with respect to all the pixels 2, a triangle which is a new picture is displayed at the display section 3, and the rewrite operation is completed (see FIG. 9E).

At this time, the pixels A, B, and C operate in a manner as shown in FIGS. 10D and 10E. In the write operation, if the image signal DW is inputted into the picture electrode 21, the potential of the picture electrode 21 of the pixel A will change to DL from DH, and the potential of the picture electrode 21 of the pixel B will change to DH from DL, but the potential of the picture electrode 21 of the pixel C will not change, but remains at DL.

For this reason, a large potential difference is not created between both electrodes in each of the pixels A and C when the potential Vcom of the common electrode 22 is COML. Accordingly, electrophoresis particles negligibly move. Therefore, a white display is maintained in the pixels A can C. On the other hand, in the pixel B, a large potential difference is created between both electrodes, and the white particles 32 move to the picture electrode 21 and the black particles 33 move to the common electrode 22. Although a large potential difference is created in pixels A and C when the potential Vcom of the common electrode 22 is COML, since the period in which the potential Vcom of the common electrode 22 is COMH is very short, this does not have big influence on movement of electrophoresis particles. Moreover, though electrophoresis particles move, since the white particles 32 can be drawn near to the common electrode 22 and the black particles 33 can be drawn near to the picture electrode 21, the white display can be maintained. Since a large potential difference is not created between both the electrodes of Pixel B, movement of the electrophoresis particles is not influenced by the potential difference but is slowed down by the collision with dispersion medium 31. By repeating such operation, the pixels A, B, and C fall to the state shown in FIG. 10E in which white is displayed by the pixels A and C and black is displayed by the pixel B through the state shown in FIG. 10D.

As for the rewrite operation, it is mentioned that the rewrite operation is set such that the write operation is started when the predetermined period T2 passes after the erase operation is started, so that the write operation with respect to the pixels 2 connected to the write scan line YW1 can start before the pixels 2 connected to the erase scan line Ym undergo the erase operation by setting up T2 short. Here, if the write time T3 is shortened further, the pixels 2 connected to the erase scan line YE1 can undergo the erase operation before the write operation is performed with respect to the pixels 2 connected to the write scan line YWm. By this, it becomes possible to rewrite a picture continuously and an animation can be reproduced smoothly.

### Second Embodiment

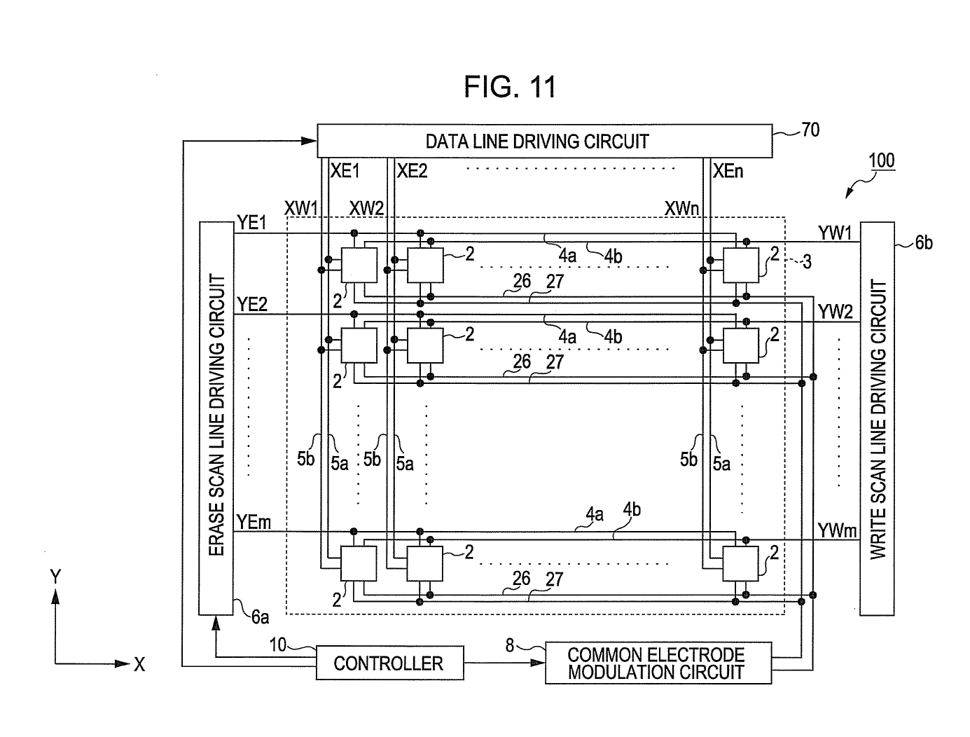

FIG. 11 shows a structure of an electrophoresis display device 100 according to a second embodiment. The second embodiment is different from the first embodiment from the standpoint that the electrophoresis display device 100 is driven by a single data line driving circuit 70 as compared to the electrophoresis display device 1 which uses two data line driving circuits, and thus an erase data line 5a and a write data line 5b are connected to the single data line driving circuit 70. By this structure, it is possible to input the erase signal DE into the pixels 2 via the erase data line 5a and also to input the image signal DW into the pixels 2 via the write data line 5b by the data line driving circuit 70.

The pixels 2 selected by the erase scan line driving circuit 6a are applied with the erase signal DE via the erase data line 5a, and the pixels 2 selected by the write scan line driving circuit 6b are applied with the image signal DW via the write data line 5b.

In the case in which the timing in which the erase scan line driving circuit 6a selects the pixels 2 for erase and the timing in which the write scan line driving circuit 6b selects the pixels 2 for write are coincident, the erase signal DE and the image signal DW can be simultaneously supplied to the erase data line 5a and the write data line 5b and inputted into the selected pixels 2, respectively. As a result, it is possible to simplify the operation of the data line driving circuit 70.

### Third Embodiment

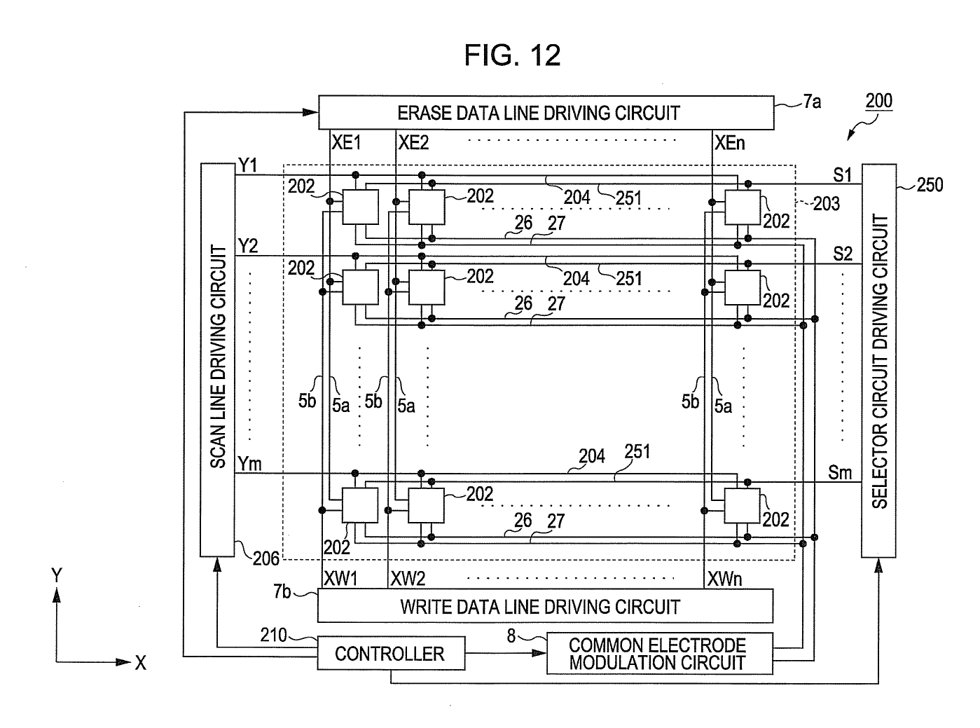

FIG. 12 shows a structure of an electrophoresis display device 200 according to a third embodiment. A scan line driving circuit 206 is connected to pixels 202 via scan lines 204. An erase data line driving circuit 7a is connected to the pixels 202 through erase data lines 5a. A write data line driving circuit 7b is connected to the pixels 202 via write data lines 5b. A common electrode modulation circuit 8 is connected to the pixels 202 via a common electrode power supply wiring 26 and a holding capacitor power supply wiring 27. A selector circuit driving circuit 250 is connected to the pixels 202 via a selector circuit driving wiring 251.

The pixels 202 are provided in the display section 203 in the form of a matrix of M (Y-axis direction)×N (X-axis direction). M lines of selector circuit driving wiring 251 (S1, S2, . . . , Sm) extend along the display section 203 in the X-axis direction. M lines of scan lines 204 (Y1, Y2, . . . , Ym) extend along the display section 203 in the X-axis direction. N lines of erase data lines 5a (XE1, XE2, . . . , XEn) and N lines of write data lines 5b (XW1, XW2, . . . , XWn) extend along the display section 203 in the Y-axis direction.

The scan line driving circuit 206, the erase data line driving circuit 7a, the write data line driving circuit 7b, the common electrode modulation circuit 8, and the selector circuit driving circuit 250 are controlled by a controller 210.

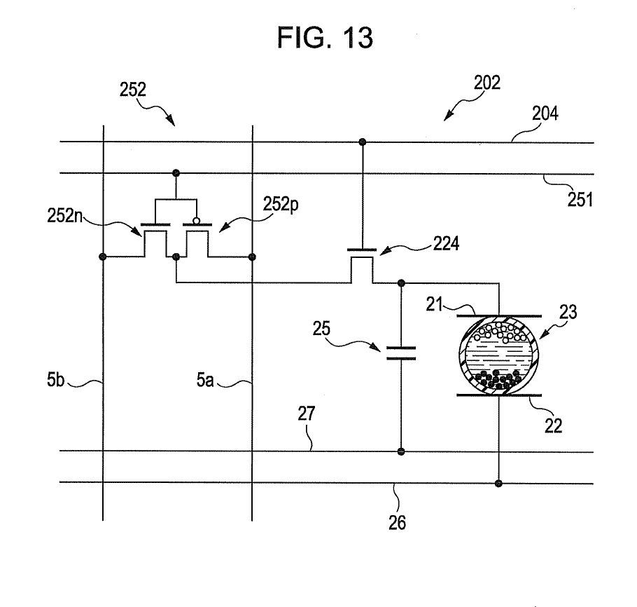

FIG. 13 shows a circuit structure of the pixel 202 shown in FIG. 12. The selector circuit 252 is connected with a source of a driving TFT 224. The selector circuit is connected with the erase data line 5a, the write data line 5b, and the selector circuit driving wiring 251.

The selector circuit 252 is connected with the driving TFT 224 via the selector circuit driving wiring 251 by selecting either one data line of the erase data line 5a and the write data line 5b on the basis of a select signal inputted from the selector circuit driving circuit 250.

An example of the selector circuit 252 consists of a P-MOS element 252p and an N-MOS element 252n connected with each other in parallel. A source of the P-MOS element 252p is connected with the erase data line 5a and a source of the N-MOS element 252n is connected with the write data line 5b. Gates of the P-MOS element 252p and the N-MOS element 252n are connected with the selector circuit driving wiring 251.

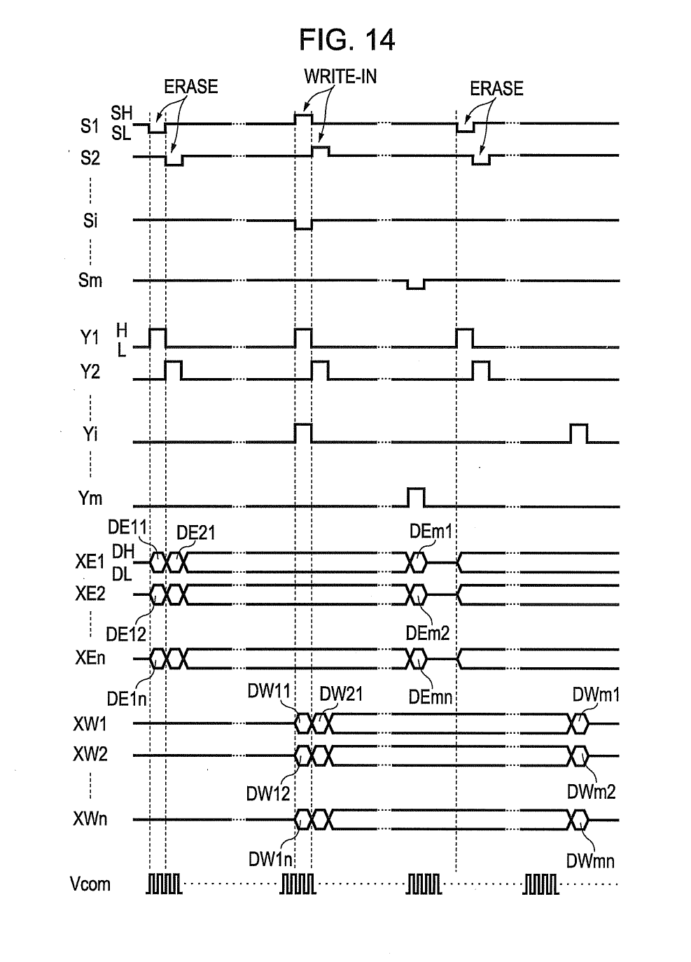

FIG. 14 is timing chart according to the third embodiment. When performing the erase operation with respect to the pixels 202 connected to one scan line Yi, low-level SL is inputted into a selector circuit driving wiring Si. Thus, the erase data line 5a connected to the P-MOS element and the driving TFT 224 are connected with each other, and the erase signal DE is inputted into the source of the driving TFT 224.

The same operation as in the first embodiment and the second embodiment is performed after this, and thus it is possible to erase a picture.

On the other hand, at the time of performing the write operation, the selector circuit driving wiring Si is inputted with high-level SH. By this, the erase data line 5b connected to the N-MOS element and the driving TFT 224 are connected with each other, and the source of the driving TFT 224 is inputted with the image signal DW.

The same operation as in the first embodiment and the second embodiment is performed after this, and thus it is possible to write a picture.

By the presence of the selector circuit, it is possible to realize the electrophoresis display device 200 which can perform the erase operation and the write operation with a single driving TFT 224.

### Electronic Apparatus

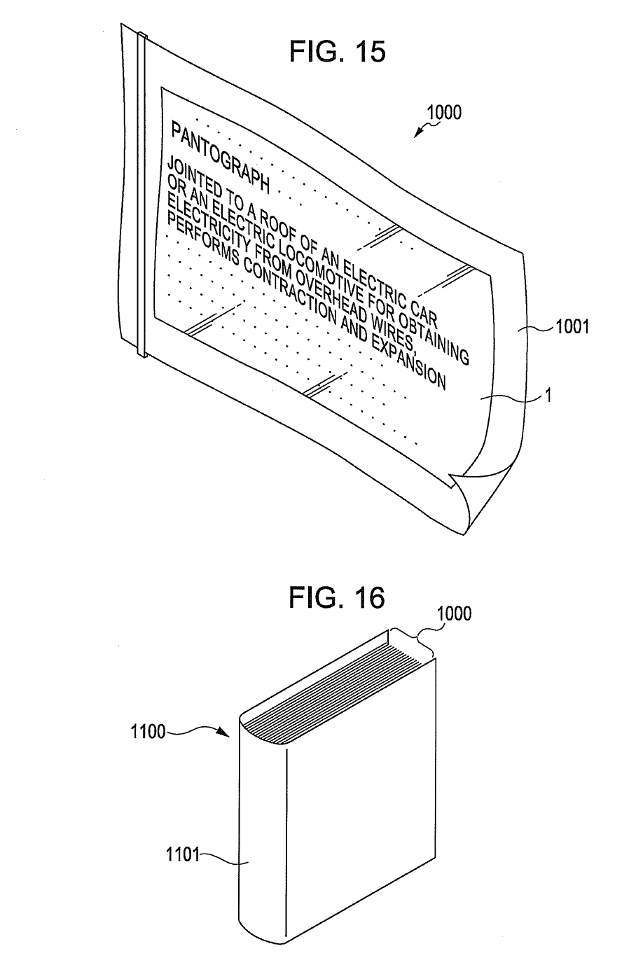

FIG. 15 shows an example of the electronic apparatus equipped with the electrophoresis display device 1 according to the invention. The electrophoresis display device 1 mentioned above is applied to various electronic apparatuses, and the examples of the electronic apparatus equipped with the electrophoresis display device 1 will be described below. First, an example that the electrophoresis display device 1 is applied to flexible electronic paper will be explained. FIG. 15 is a perspective view showing a structure of the electronic paper, and the electronic paper 1000 is equipped with the electrophoresis display device 1 of the invention as a display section. The electronic paper 1000 has a structure in which the electrophoresis display device 1 of the invention is provided to the surface of main part 1001 thereof which consists of a sheet which has the same conventional textures and pliability as paper.

FIG. 16 is a perspective view showing a structure of an electronic note 1100. The electronic note 1100 includes a plurality of sheets of electronic paper 1000 shown in FIG. 15, which are bundled together and covered with a cover 1101. The cover 1101 is equipped with a display data input unit (not shown) which receives display data sent, for example from an external device. Thereby, contents of a display can be changed or updated according to the display data in the state in which the electronic paper 1000 is bundled.

Moreover, in addition to the above-mentioned electronic apparatuses, there are many other examples of the electronic apparatus, such as a liquid crystal television, a videotape recorder of a view finder type or a monitor type, a car navigation apparatus, a pager, an electronic notebook, a calculator, a word processor, a workstation, a TV phone, a POS terminal, and apparatuses equipped with a touch panel. The electrophoresis display device 1 according to the invention is applicable as a display section of such an electronic apparatus.

What is claimed is:

1. An electrophoresis display device comprising:
a first electrode;
a second electrode facing the first electrode;
an electrophoresis element interposed between the first electrode and the second electrode and containing charged electrophoresis particles;
a pixel including a first pixel circuit and a second pixel circuit which give a potential difference between the first electrode and the second electrode;
a first scan line and a first data line which are connected to the first pixel circuit; and
a second scan line and a second data line which are connected to the second pixel circuit,
wherein a signal supplied to the first pixel circuit from the first data line during a select period specified by a select signal of the first scan line is an erase signal, and wherein a signal supplied to the second pixel circuit from the second data line during a select period specified by a select signal of the second scan line is an image signal.

2. The electrophoresis display device according to claim 1, further comprising:
a first scan line driving circuit connected to the first scan line;
a second scan line driving circuit connected to the second scan line; and
a data line driving circuit connected to the first data line and the second data line.

3. The electrophoresis display device according to claim 1, further comprising:
a first scan line driving circuit connected to the first scan line;
a second scan line driving circuit connected to the second scan line;
a first data line driving circuit connected to the first data line; and
a second data line driving circuit connected to the second data line.

4. The electrophoresis display device according to claim 2, wherein the pixel is made such that the select signal by the first scan line and the select signal by the second scan line are not simultaneously supplied.

5. The electrophoresis display device according to claim 1, wherein a display section of the electrophoresis display device includes a plurality of the pixels, and wherein supply of the select signal by the first scan line to a first pixel in the display section and supply of the select signal by the second scan line to a second pixel in the display section are carried out concurrently with each other.

6. The electrophoresis display device according to claim 1, wherein the erase signal is an inversion signal of the image signal which is inputted into the same pixel just previously.

7. An electrophoresis display device comprising:
a first electrode;
a second electrode facing the first electrode;
an electrophoresis element interposed between the first electrode and the second electrode and containing charged electrophoresis particles;
a pixel circuit giving a potential difference between the first electrode and the second electrode;
a scan line connected to the pixel circuit; and
a data select circuit which is connected to the pixel circuit, a first data line, and a second data line and which switches a data input signal inputted into the pixel circuit between the first data line and the second data line.

8. The electrophoresis display device according to claim 7, further comprising:
a scan line driving circuit which drives a signal of the scan line;
a first data line driving circuit which drives the first data line;
a second data line driving circuit which drives the second data line; and
a control unit which controls the scan line driving circuit, the first data line driving circuit, the second data line driving circuit, and the data select circuit.

9. The electrophoresis display device according to claim 7, wherein a display section of the electrophoresis display device includes a plurality of the pixel circuits, and wherein a first select period specified by a signal of the scan line to be inputted into the first pixel circuit in which a signal of the first data line is selected as the data input signal and a second select period specified by a signal of the scan line to be inputted into the second pixel circuit in which a signal of the second data line is selected as the data input signal concurrently occur.

10. The electrophoresis display device according to claim 7, wherein the signal of the first data line is an erase signal and the signal of the second data line is an image signal.

11. The electrophoresis display device according to claim 7, wherein the erase signal is an inversion signal of the image signal into the same pixel just previously.

12. A driving method of an electrophoresis display device including:
a first electrode;
a second electrode facing the first electrode;
an electrophoresis element interposed between the first electrode and the second electrode and containing charged electrophoresis particles;
a first pixel circuit connected to a first scan line and a first data line which give a potential difference between the first electrode and the second electrode;
a second pixel circuit connected to a second scan line and a second data line which give a potential difference between the first electrode and the second electrode; and
a pixel including the first pixel circuit and the second pixel circuit, wherein a display section of the electrophoresis display device includes a plurality of the pixels, the driving method comprising:
a first step of supplying a select signal of the first scan line to the first pixel circuit of the pixel of a first region of the display section and an erase signal to the first data line to;
a second step of supplying a select signal of the second scan line to the second pixel circuit of the pixel of the first region and an image signal to the second data line;
a third step of supplying a select signal of the first scan line to the first pixel circuit of the pixel of a second region of the display section and an erase signal to the first data line; and
a fourth step of supplying a select signal of the second scan line to the second pixel circuit of the pixel of the second region and an image signal to the second data line,
wherein the electrophoresis display device has a first period in which the first step and the fourth step are simultaneously performed and a second period in which the second step and the third step are simultaneously performed.

13. The driving method of an electrophoresis display device according to claim 12, wherein input of the select signal via the first scan line and input of the select signal via the second scan line are coincidently performed at the same timing.

14. The driving method of an electrophoresis display device according to claim 12, wherein the erase signal is an inversion signal of the image signal just previously inputted into the same pixel.

15. An electronic apparatus comprising the electrophoresis display device according to claim 1.
